(19) United States
(12) Patent Application Publication
(10) Pub. No.: US 2026/0320821 A1
(43) Pub. Date: Oct. 15, 2026

(54) DISTANCE MEASURING DEVICE

(71) Applicant: Panasonic Intellectual Property Management Co., Ltd., Osaka (JP)

(72) Inventor: MASAHARU FUKAKUSA, Kumamoto (JP)

(21) Appl. No.: 19/120,113

(22) PCT Filed: Oct. 24, 2023
(86) PCT No.: PCT/JP2023/038401

§ 371 Date: Apr. 10, 2025

(30) Foreign Application Priority Data
Nov. 25, 2022 (JP) 2022-188321

(51) Int. Cl. G06T 7/73; H04N 13/239; H04N 13/254; H04N 23/74

(52) U.S. Cl. CPC G06T 7/74; H04N 13/239; H04N 13/254; H04N 23/74; G06T 2207/10012; G06T 2207/10028

(57) ABSTRACT

Distance measurement device includes: first imaging part and second imaging part; light projector that projects pattern light; and measurement part that measures a distance to a surface of object on which pattern light is projected, based on images captured by first imaging part and second imaging part. Light projector includes: light sources including multiple types of wavelength bands; filter in which multiple types of filter regions for respectively forming multiple types of light regions are distributed in a pattern similar to a pattern of the light regions; and multiple optical elements that are arranged on at least one of an incident surface side and an emission surface side of the filter regions. The optical element enables projection of the light region so as to have first focal point and second focal point on a side farther from distance measurement device than first focal point.

### TECHNICAL FIELD

The present disclosure relates to a distance measurement device.

### BACKGROUND ART

Conventionally, a distance measurement device has been known which processes an image acquired by a stereo camera to measure a distance to an object. This device detects a parallax from images captured by a pair of cameras. A pixel block having the highest correlation with a target pixel block on an image (standard image) captured by one of the cameras is searched for on an image (reference image) captured by the other camera. A search range is set in a direction, in which the camera moves away, with the same position as the target pixel block as a standard position. The amount of pixel shift of the pixel block extracted by the search with respect to the standard position is detected as a parallax. The distance to the object is calculated from the parallax by a triangulation method.

In a mapping method in three-dimensional optical distance measurement of PTL 1, a light beam is divided into multiple spots, spots having a shape characteristic that changes by a predetermined method with distance along an optical axis of the light beam are formed, and a pattern of the spots is projected onto an object. In PTL 1, positions of the spots in the pattern are uncorrelated.

A three-dimensional measurement system of PTL 2 includes a first imaging part and a second imaging part disposed to be separated from each other. The three-dimensional measurement system of PTL 2 calculates, using images of a target object captured by the first imaging part and the second imaging part, a parallax at first feature points in the images of the target object by image processing based on a pattern projection method. In addition, the three-dimensional measurement system of PTL 2 searches, using both the images of the target object captured by the first imaging part and the second imaging part, for corresponding points for second feature points in the images of the target object by image processing based on a stereo camera method, calculates a parallax at the second feature points on the basis of a result of the search, and specifies a three-dimensional shape of the target object on the basis of the parallax at the first feature points and the parallax at the second feature points.

### CITATION LIST

### Patent Literatures

PTL 1: Japanese Patent No. 5592070
PTL 2: Unexamined Japanese Patent Publication No. 2021-192064

### SUMMARY OF THE INVENTION

However, in the distance measurement device of PTL 1, since the positions of the spots in the pattern are uncorrelated, the interval between the spots cannot be reduced. For this reason, a portion where no spot light is projected increases, and the resolution of the distance measurement device cannot be increased.

Meanwhile, since the three-dimensional measurement system of PTL 2 searches for the corresponding points by the image processing based on the stereo camera method after performing the image processing based on the pattern projection method on the images of the target object captured by the first imaging part and the second imaging part, it takes time to measure the distance.

An objective of the present disclosure is to provide a distance measurement device capable of reducing time required for distance measurement while increasing resolution.

In order to solve the above problem, a distance measurement device according to an exemplary embodiment of the present disclosure includes: a first imaging part and a second imaging part that are disposed side by side, visual fields of the first imaging part and the second imaging part having a range overlapping with each other; a light projector that projects pattern light in a range in which the visual fields overlap with each other, the pattern light having multiple light regions of different wavelength bands that are distributed in a predetermined pattern; and a measurement part that measures a distance to a surface of an object, on which the predetermined pattern light is projected, based on images captured by the first imaging part and the second imaging part. The light projector includes: a light source including the wavelength bands; a filter including multiple filter regions for respectively forming the multiple light regions distributed in a pattern similar to the predetermined pattern of the light regions; and multiple optical elements that are arranged on at least one of an incident surface side and an emission surface side of the filter regions. The optical element has two different focal points and forms the light region.

According to the distance measurement device of the present disclosure, it is possible to reduce time required for distance measurement while increasing resolution.

### BRIEF DESCRIPTION OF THE DRAWINGS

FIG. 1 is a diagram illustrating a basic configuration of a distance measurement device according to an exemplary embodiment.

FIG. 2 is a diagram illustrating a configuration of the distance measurement device according to the exemplary embodiment.

FIG. 3A is a diagram schematically illustrating a method of setting a pixel block for an entire first image according to the exemplary embodiment.

FIG. 3B is a diagram schematically illustrating the method of setting a pixel block for the first image according to the exemplary embodiment by magnifying a partial region of the first image.

FIG. 4A is a diagram schematically illustrating a configuration of a filter according to the exemplary embodiment.

FIG. 4B is a diagram illustrating the configuration of the filter according to the exemplary embodiment by magnifying a partial region of FIG. 4A.

FIG. 5A is a perspective view of the filter according to the exemplary embodiment.

FIG. 5B is a perspective view illustrating the filter according to the exemplary embodiment in which a microlens is omitted.

FIG. 6A is a schematic diagram illustrating an example of pattern light according to the exemplary embodiment in a case where the height of an object is h1.

FIG. 6B is a schematic diagram illustrating an example of the pattern light according to the exemplary embodiment in a case where the height of the object is h2.

FIG. 6C is a schematic diagram illustrating an example of the pattern light according to the exemplary embodiment in a case where the height of the object is h3.

FIG. 6D is a schematic diagram illustrating an example of the pattern light according to the exemplary embodiment in a case where the height of the object is h4.

FIG. 7A is a graph illustrating a spectral output of light sources for describing wavelength bands output from light sources according to the exemplary embodiment.

FIG. 7B is a graph illustrating spectral transmittances of filter regions for describing the wavelength bands output from the light sources according to the exemplary embodiment.

FIG. 8 is a flowchart for describing a method of calculating a distance index value of a measurement part according to the exemplary embodiment.

FIG. 9A is a diagram illustrating an example of luminance values in a pixel block according to the exemplary embodiment in a case where the height of the object is h1.

FIG. 9B is a diagram illustrating an example of the luminance values in the pixel block according to the exemplary embodiment in a case where the height of the object is h2.

FIG. 9C is a diagram illustrating an example of the luminance values in the pixel block according to the exemplary embodiment in a case where the height of the object is h3.

FIG. 9D is a diagram illustrating an example of the luminance values in the pixel block according to the exemplary embodiment in a case where the height of the object is h4.

FIG. 10A is a schematic diagram illustrating an example of luminance values when the pixel block according to FIG. 9A is divided into four regions.

FIG. 10B is a schematic diagram illustrating an example of luminance values when the pixel block according to FIG. 9B is divided into four regions.

FIG. 10C is a schematic diagram illustrating an example of luminance values when the pixel block according to FIG. 9C is divided into four regions.

FIG. 10D is a schematic diagram illustrating an example of luminance values when the pixel block according to FIG. 9D is divided into four regions.

FIG. 11A is a diagram schematically illustrating, for the purpose of describing a method of searching for a target pixel block according to the exemplary embodiment, a state in which the target pixel block is set on a first image.

FIG. 11B is a diagram schematically illustrating, for the purpose of describing the method of searching for a target pixel block according to the exemplary embodiment, a search range set on a second image for searching for the target pixel block in FIG. 11A.

FIG. 12 is a diagram illustrating a configuration of a distance measurement device according to a modification.

FIG. 13A is a diagram illustrating a spectral output of a light source for describing a wavelength band output from a light source according to the modification.

FIG. 13B is a diagram illustrating spectral transmittances of filter regions for describing the wavelength band output from the light source according to the modification.

FIG. 14 is a perspective view of a filter according to the modification.

### DESCRIPTION OF EMBODIMENT

Hereinafter, an exemplary embodiment of the present disclosure will be described in detail with reference to the drawings. The following description of the preferred exemplary embodiment is merely illustrative in nature and is not intended to limit the technique of the present disclosure, its application, or uses.

### Exemplary Embodiment

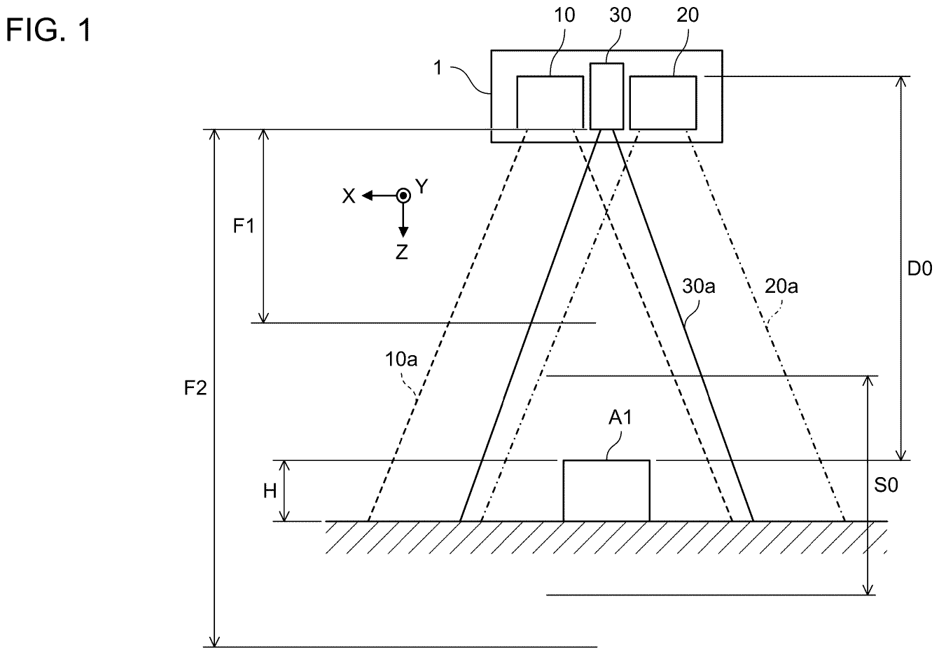

FIG. 1 is a diagram illustrating a basic configuration of distance measurement device 1 according to an exemplary embodiment.

As illustrated in FIG. 1, distance measurement device 1 includes first imaging part 10, second imaging part 20, and light projector 30.

First imaging part 10 is configured to capture an image of a range of visual field 10a oriented in the Z-axis positive direction. Second imaging part 20 is configured to capture an image of a range of visual field 20a oriented in the Z-axis positive direction. First imaging part 10 and second imaging part 20 are disposed side by side at a predetermined distance (base-line length) from each other in the X-axis direction so that visual fields 10a, 20a have a range overlapping with each other. An imaging direction of first imaging part 10 may be slightly inclined from the Z-axis positive direction toward second imaging part 20, and an imaging direction of second imaging part 20 may be slightly inclined from the Z-axis positive direction toward first imaging part 10. The positions of first imaging part 10 and second imaging part 20 in the Z-axis direction and the Y-axis direction are the same. Note that the “imaging direction” is a direction of the optical axis of first imaging part 10 or a direction of the optical axis of second imaging part 20.

Light projector 30 is configured to project pattern light 30a, in which light is distributed in a predetermined pattern, in a range in which visual field 10a and visual field 20a overlap with each other. A projection direction of pattern light 30a of light projector 30 is the Z-axis positive direction. Pattern light 30a is projected onto the surface of object A1 existing in a range where visual fields 10a, 20a overlap with each other.

Distance measurement device 1 measures distance D0 to object A1 by stereo corresponding point search using the captured images captured by first imaging part 10 and second imaging part 20. At this time, pattern light 30a is projected from light projector 30 onto the surface of object A1. As a result, a pattern of pattern light 30a is projected in the captured images of first imaging part 10 and second imaging part 20. Therefore, even when the surface of object A1 is plain, the stereo corresponding point search can be performed with high accuracy, and distance D0 to the surface of object A1 can be accurately measured.

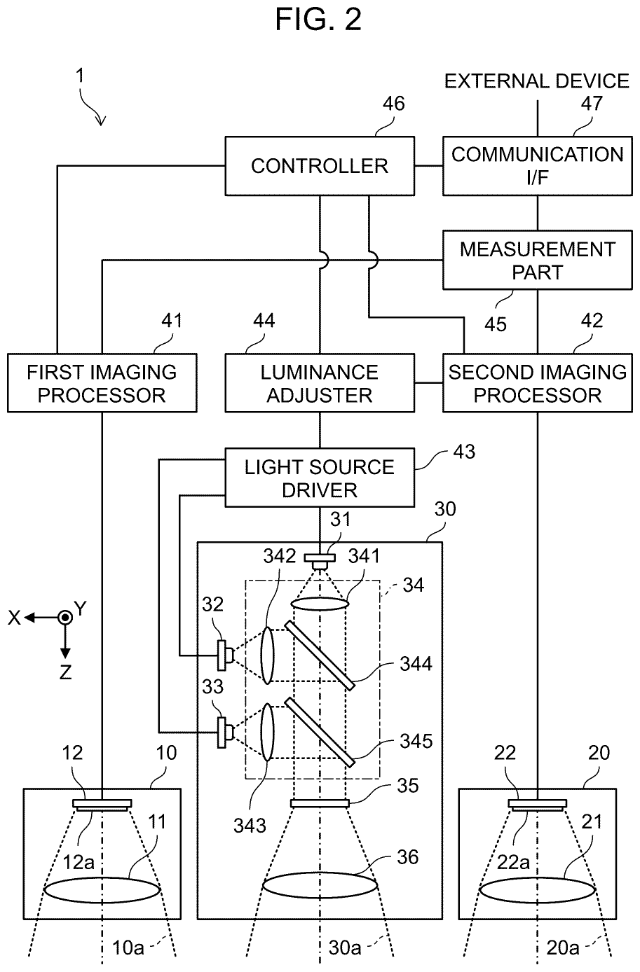

FIG. 2 is a diagram illustrating a configuration of the distance measurement device according to the exemplary embodiment.

First imaging part 10 includes imaging lens 11 and imaging element 12. Imaging lens 11 has a focal distance and condenses light from visual field 10a on imaging surface 12a of imaging element 12. Imaging lens 11 does not necessarily have to be a single lens, and may be configured by combining multiple lenses. Imaging element 12 is a monochrome image sensor. Imaging element 12 is, for example, a complementary metal oxide semiconductor (CMOS) image sensor. Note that imaging element 12 may be a charge coupled device (CCD).

Second imaging part 20 has a configuration similar to first imaging part 10. Specifically, second imaging part 20 includes imaging lens 21 and imaging element 22. Imaging lens 21 has the same focal distance as imaging lens 11, and condenses light from visual field 20a on imaging surface 22a of imaging element 22. Imaging lens 21 does not necessarily have to be a single lens, and may be configured by combining multiple lenses. Imaging element 22 is a monochrome image sensor. Note that imaging element 22 is, for example, a CMOS image sensor. Imaging element 22 may be a CCD.

Light projector 30 includes light sources 31 to 33, optical system 34, filter 35, and projection lens 36.

Light sources 31 to 33 emit light of different wavelength bands. For example, light source 31 emits light of a wavelength band near red, light source 32 emits light of a wavelength band near green, and light source 33 emits light of a wavelength band near blue. Light sources 31 to 33 are, for example, light-emitting diodes. Note that light sources 31 to 33 may be another type of light source such as semiconductor lasers.

Optical system 34 includes collimator lenses 341 to 343 and dichroic mirrors 344, 345. Collimator lenses 341 to 343 convert light, emitted from light sources 31 to 33, into substantially parallel light. Dichroic mirror 344 transmits light incident from collimator lens 341 and reflects light incident from collimator lens 342. Dichroic mirror 345 transmits light incident from dichroic mirror 344 and reflects light incident from collimator lens 343. In this manner, light beams emitted from light sources 31 to 33 are integrated and guided to filter 35.

Filter 35 generates pattern light 30a, in which multiple types of light regions having different wavelength bands are distributed in a predetermined pattern, from the light beams of wavelength bands guided from optical system 34. Note that a specific configuration of filter 35 will be described later.

Projection lens 36 projects pattern light 30a generated by filter 35. Projection lens 36 does not necessarily have to be a single lens, and may be configured by combining multiple lenses.

Distance measurement device 1 includes, as a configuration of a circuit, first imaging processor 41, second imaging processor 42, light source driver 43, luminance adjuster 44, measurement part 45, controller 46, and communication interface 47.

First imaging processor 41 and second imaging processor 42 are configured to control imaging elements 12, 22, and perform processing such as luminance correction and camera calibration on pixel signals of a first image and a second image output from imaging elements 12, 22, respectively.

Light source driver 43 is configured to drive each of light sources 31 to 33 with a drive current value set by luminance adjuster 44.

Luminance adjuster 44 is configured to set a drive current value of each of light sources 31 to 33 in light source driver 43 on the basis of the pixel signal (luminance) of the second image input from second imaging processor 42. Specifically, luminance adjuster 44 sets the drive current value (amount of light emission) of each of light sources 31 to 33 so that the maximum luminance based on the light beams from light sources 31 to 33 acquired on the basis of the pixel signal from second imaging part 20 is not saturated.

Measurement part 45 is configured to perform stereo corresponding point search by performing comparison processing on the first image and the second image input from first imaging processor 41 and second imaging processor 42, respectively, to acquire the distance to the surface of object A1 for each pixel block on the first image. Measurement part 45 transmits the acquired distance information for all the pixel blocks to an external device via communication interface 47.

In other words, measurement part 45 sets a pixel block as a distance acquisition target (hereinafter referred to as “target pixel block”) on the first image, and searches a search range, defined on the second image, for a pixel block corresponding to the target pixel block, that is, a pixel block most fitted to the target pixel block (hereinafter referred to as “fitted pixel block”). Then, measurement part 45 performs processing of acquiring the amount of pixel shift between a pixel block located at the same position as the target pixel block on the second image (hereinafter referred to as “standard pixel block”) and the fitted pixel block extracted from the second image by the search, and calculating a distance to the surface of object A1 at the position of the target pixel block on the basis of the amount of pixel shift thus acquired.

Measurement part 45 and communication interface 47 may be configured by a semiconductor integrated circuit including a field programmable gate array (FPGA). In addition, each of these parts may be configured by other semiconductor integrated circuits such as a digital signal processor (DSP), a graphics processing unit (GPU), and an application specific integrated circuit (ASIC).

Controller 46 includes a microcomputer or the like, and is configured to control each of the parts according to a predetermined program stored in a built-in memory.

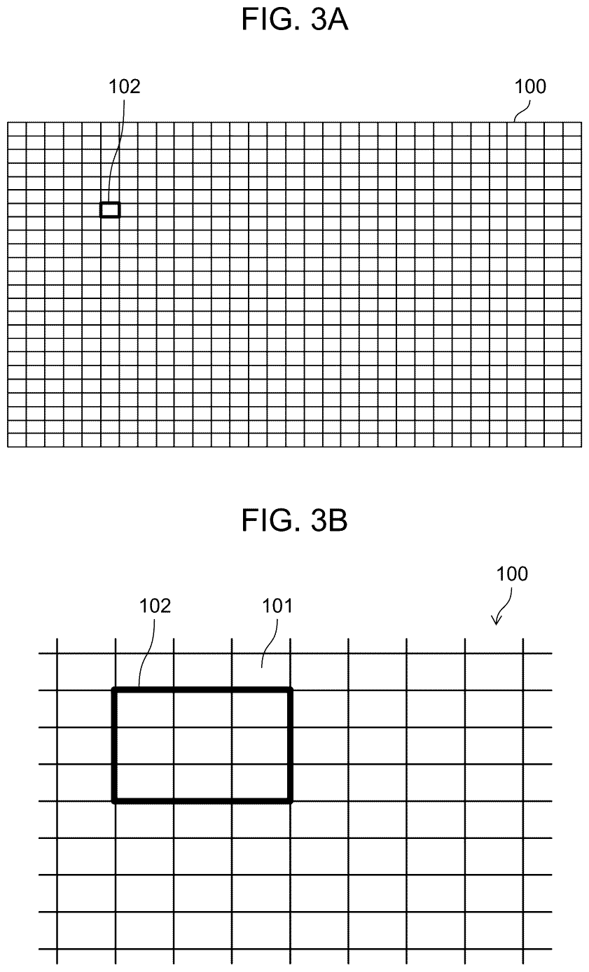

FIGS. 3A and 3B are diagrams schematically illustrating a method of setting a pixel block for the first image. Specifically, FIG. 3A illustrates a method of setting pixel block 102 for entire first image 100, and FIG. 3B illustrates a partial region of first image 100 in a magnified manner.

As illustrated in FIGS. 3A and 3B, first image 100 is divided into multiple pixel blocks 102 each including a predetermined number of pixel regions 101. Each pixel region 101 is a region corresponding to one pixel on imaging element 12. In other words, pixel region 101 is a minimum unit of first image 100. In the example of FIGS. 3A and 3B, one pixel block 102 is constituted by nine pixel regions 101 arranged in three rows and three columns. However, the number of pixel regions 101 included in one pixel block 102 is not limited thereto.

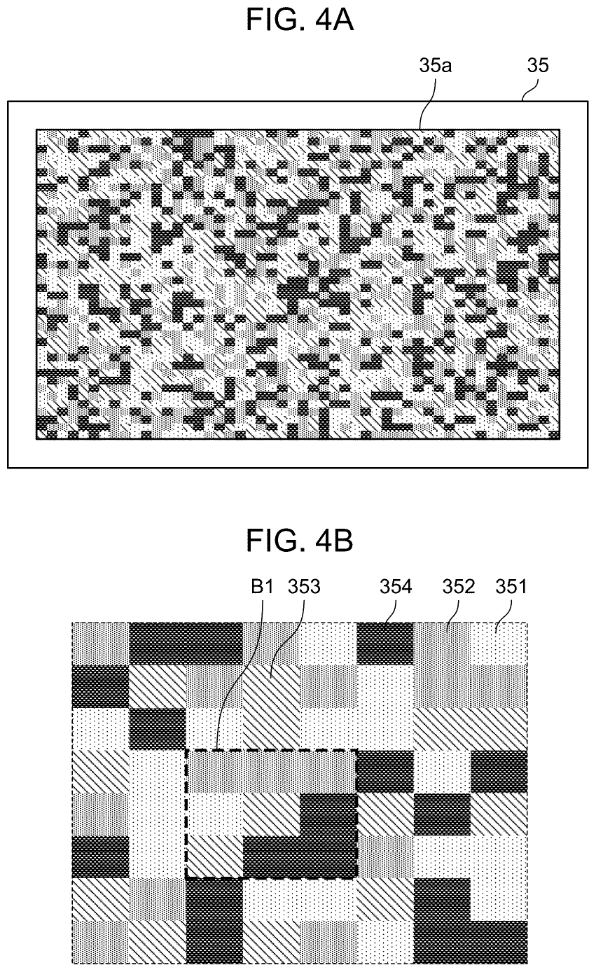

FIGS. 4A and 4B are diagrams illustrating a configuration of the filter according to the exemplary embodiment. Specifically, FIG. 4A is a diagram schematically illustrating a configuration of filter 35. FIG. 4B is a magnified diagram of a partial region of FIG. 4A. FIGS. 4A and 4B illustrate a state in which filter 35 is viewed from light incident surface 35a side.

As illustrated in FIGS. 4A and 4B, multiple types of filter regions 351 to 354 are formed in a predetermined pattern in filter 35. In FIGS. 4A and 4B, the types of filter regions 351 to 354 are indicated by different types of hatching. Filter regions 351 to 354 selectively transmit light beams of different wavelength bands to form light regions of different hues. Here, filter region 351 forms a light region corresponding to the hue “red”, filter region 352 forms a light region corresponding to the hue “orange”, filter region 353 forms a light region corresponding to the hue “green”, and filter region 354 forms a light region corresponding to the hue “blue”. The characteristics of light sources 31 to 33 and filter regions 351 to 354 will be described later.

The size of each of filter regions 351 to 354 is set to, for example, a size substantially corresponding to one pixel block on imaging element 12, 22. For example, region B1 indicated by a broken line in FIG. 4B is a region corresponding to a region of a pixel block including three pixels in the vertical direction and three pixels in the horizontal direction on imaging element 12, 22 (pixel block 102 used for stereo corresponding point search described above). In other words, in a case where distance D0 to the surface of object A1 is a standard distance (for example, intermediate distance of distance measurement range), the light of region B1 is projected onto a region of a pixel block including three pixels in the vertical direction and three pixels in the horizontal direction on imaging element 12, 22. Note that the size of each of filter regions 351 to 354 is not necessarily limited to a size corresponding to one pixel. The size of each of filter regions 351 to 354 may be larger or smaller than the size corresponding to one pixel block. Further, in FIG. 4B, each of filter regions 351 to 354 is rectangular and the sizes thereof are the same as each other, but the sizes of filter regions 351 to 354 may be different from each other, and the shapes thereof may be other shapes such as a square or a circle.

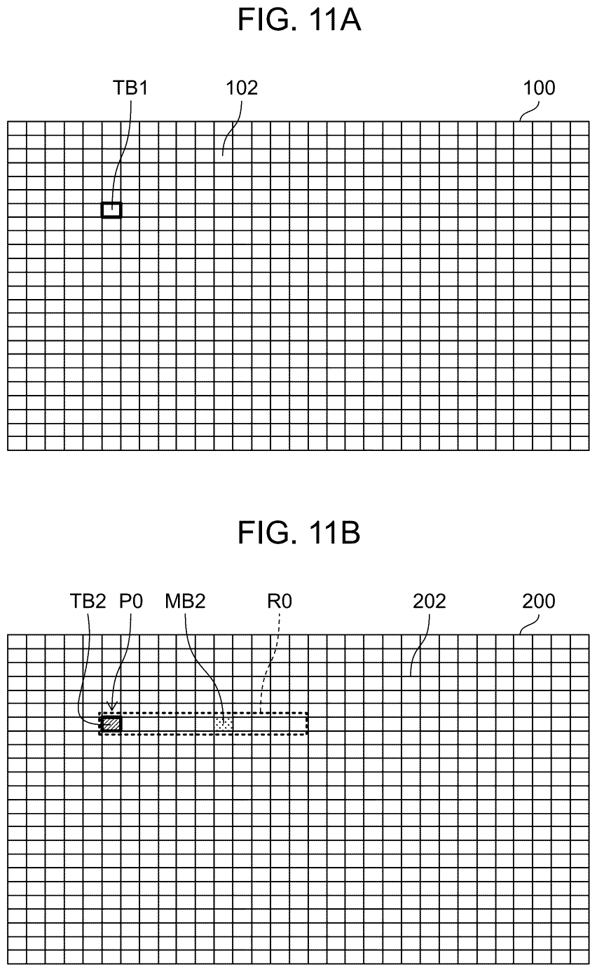

Filter regions 351 to 354 are preferably arranged so that different types of filter regions are included in each of regions B1 corresponding to all the pixel blocks used for the stereo correspondence point search, and are more preferably arranged so that all types of filter regions 351 to 354 are included in each of these regions B1. Further, an arrangement pattern of the filter regions included in region B1 corresponding to the pixel block is preferably unique (random) for each pixel block at each search position at least in search range R0 (see FIG. 11B described later) in the stereo correspondence point search.

By arrangement of filter regions 351 to 354 in this manner, as will be described later, it is possible to make the luminance distribution of light in the pixel block unique for each pixel block by making the luminance of light passing through filter regions 351 to 354 different from each other. This makes it possible to improve the accuracy of the stereo corresponding point search, and thereby improve the measurement accuracy of the distance.

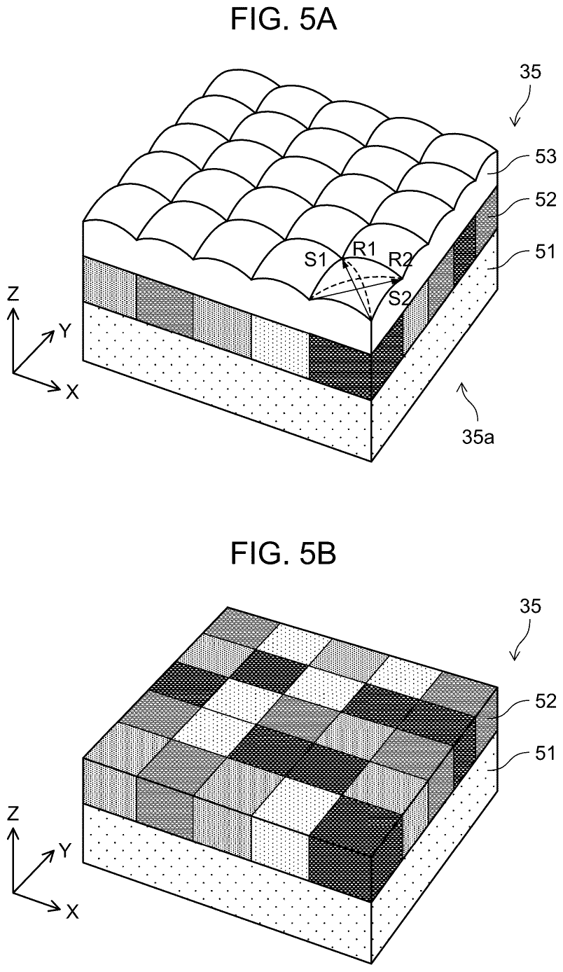

FIGS. 5A and 5B are perspective views of the filter according to the exemplary embodiment. Specifically, FIG. 5A illustrates a perspective view of filter 35, and FIG. 5B illustrates a perspective view of filter 35 with microlens 53 omitted.

As illustrated in FIG. 5A, filter 35 includes transparent base material 51, filter layer 52, and microlenses 53 (optical elements).

Transparent base material 51 is disposed on light incident surface 35a side of filter layer 52, and transmits light incident from light sources 31 to 33. Transparent base material 51 is, for example, a transparent glass substrate or the like.

In filter layer 52, multiple types of filter regions including filter regions 351 to 354 are formed in a predetermined pattern. As illustrated in FIG. 5B, each filter region formed in filter layer 52 has a square shape in plan view.

Microlenses 53 are disposed on the emission surface side of filter layer 52, and project pattern light 30a upon receiving light incident from light sources 31 to 33 via transparent base material 51 and filter layer 52. Specifically, microlenses 53 are arranged in an array in the X direction and the Y direction so as to correspond to the filter regions, respectively.

Here, microlenses 53 have different radii of curvature in two intersecting directions. In FIG. 5A, in microlens 53, curvature radius R1 in first direction S1 is different from curvature radius R2 in second direction S2. Specifically, in microlens 53, curvature radius R1 in first direction S1 is set such that focal position F1 in first direction S1 is on the side closer to distance measurement device 1 than measurement range S0 of distance measurement device 1. In addition, in microlens 53, curvature radius R2 in second direction S2 is set such that focal position F2 in second direction S1 is on the side farther from distance measurement device 1 than measurement range S0 of distance measurement device 1 (see FIG. 1). Note that first direction S1 and second direction S2 are orthogonal to each other in plan view (when viewed from light incident surface 35a side). In the calculation of a distance index value to be described later, it is more preferable that the angle of second direction S2 with respect to the X axis is set to about 45 degrees. As is apparent from the above, the focal length of microlens 53 in first direction S1 is smaller than the focal length of microlens 53 in second direction S2.

Here, microlenses whose optical surfaces are a continuous surface have been described as one exemplary embodiment of the optical element, but the present disclosure is not limited thereto, and for example, a Fresnel lens having multiple annular bands, a diffractive lens, or the like can be used.

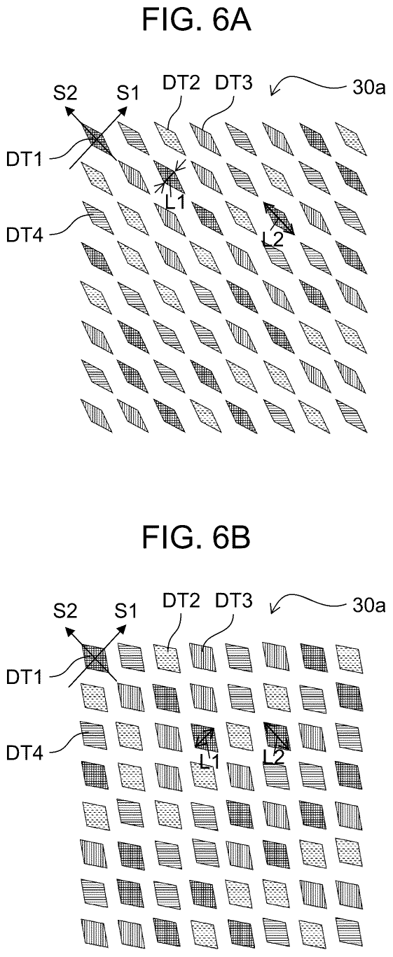

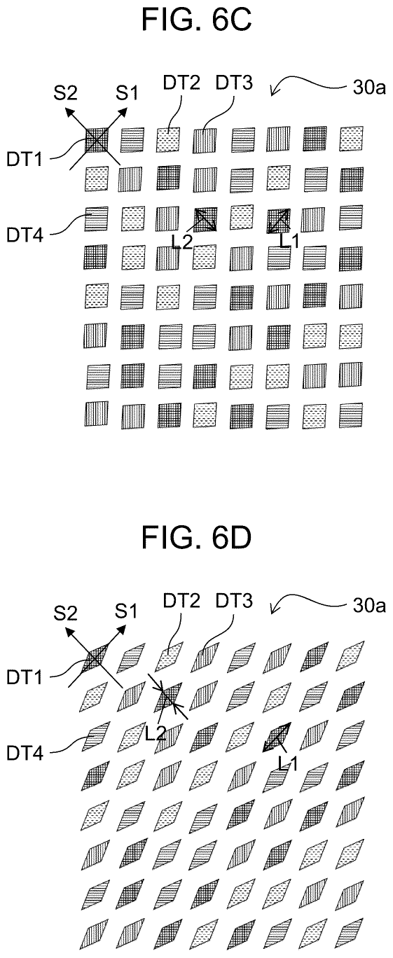

FIGS. 6A to 6D are schematic diagrams illustrating examples of pattern light according to the exemplary embodiment. Here, the measurement surface of object A1 on which the pattern light is projected is a plane (plane parallel to XY plane in FIG. 1) having the same height H (see FIG. 1). Specifically, FIGS. 6A to 6D are schematic diagrams of pattern light 30a in cases where height H of object A1 is h1 to h4, respectively. Note that heights h1 to h4 of object A1 are h1>h2>h3>h4. In other words, measurement distance D0 of distance measurement device 1 is shortest at height h1 and longest at height h4.

As illustrated in FIGS. 6A to 6D, in each pattern light 30a, dot light beams DT1 to DT4 including multiple light regions are included in an array. The multiple dot light beams DT1 to DT4 have different hues. Here, dot light beam DT1 corresponds to the hue “red”, dot light beam DT2 corresponds to the hue “orange”, dot light beam DT3 corresponds to the hue “green”, and dot light beam DT4 corresponds to the hue “blue”. The same hatching indicates dot light of the same hue.

As illustrated in FIG. 6A, in the case of height h1 of object A1, the surface of object A1 is close to focal position F1 in first direction S1 and is far from focal position F2 in second direction. Therefore, length L1 of dot light beam DT1 in first direction S1 becomes short, and length L2 of dot light beam DT1 in second direction S2 becomes long. Since dot light beams DT2 to DT4 having different hues are projected on the surface of object A1 having the same height, dot light beams DT2 to DT4 have the same pattern shape.

As illustrated in FIG. 6B, when the height of object A1 is h2, the surface of object A1 is at a position slightly farther from focal position F2 in second direction than focal position F1 in first direction S1. Therefore, length L1 of dot light beam DT1 in first direction S1 is slightly shorter than length L2 of dot light beam DT1 in second direction S2. The same applies to dot light beams DT2 to DT4.

As illustrated in FIG. 6C, when the height of object A1 is h3, the surface of object A1 is disposed at a substantially intermediate point between focal position F1 in first direction S1 and focal position F2 in second direction. Therefore, in dot light beam DT1, length L1 in first direction S1 and length L2 in second direction S2 are substantially the same. The same applies to dot light beams DT2 to DT4.

As illustrated in FIG. 6D, when the height of object A1 is h4, the surface of object A1 is far from focal position F1 in first direction S1 and close to focal position F2 in second direction. Therefore, length L1 of dot light beam DT1 in first direction S1 becomes long, and length L2 of dot light beam DT1 in second direction S2 becomes short. The same applies to dot light beams DT2 to DT4.

As described above, in the present exemplary embodiment, the shape of each dot light beam included in pattern light 30a changes according to height H (measurement distance D0) of object A1.

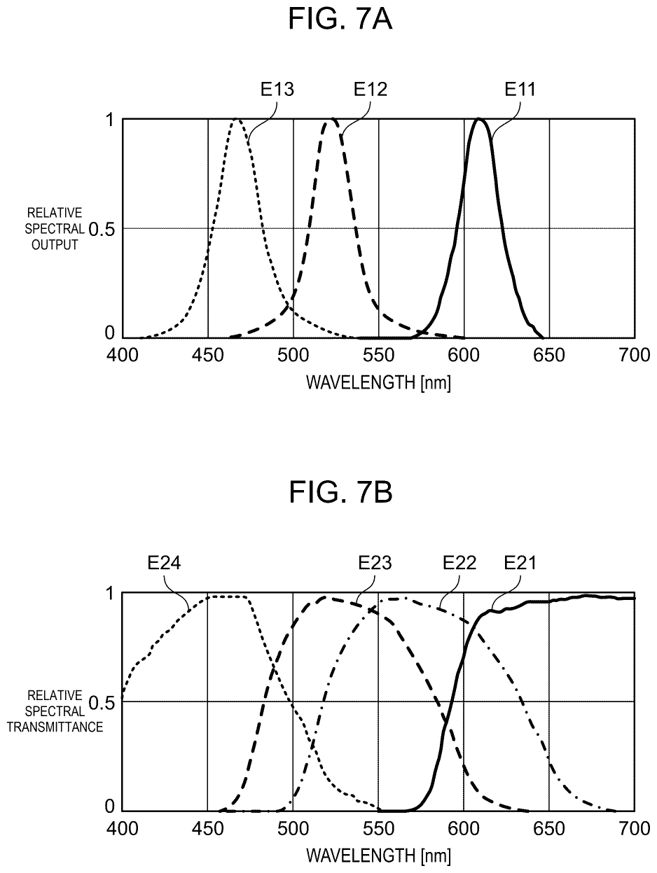

FIGS. 7A and 7B are diagrams for describing wavelength bands output from the light sources according to the exemplary embodiment.

FIG. 7A is a graph illustrating a spectral output of light sources 31 to 33. The spectral outputs of light sources 31, 32 and 33 are indicated by solid line E11, broken line E12, and dotted line E13, respectively. Here, the vertical axis of the graph is normalized by the maximum output of light source 31.

Light source 31 emits light having a center wavelength of about 610 nm and an emission bandwidth of about 80 nm. Light source 32 emits light having a center wavelength of about 520 nm and an emission bandwidth of about 150 nm. Light source 33 emits light having a center wavelength of about 470 nm and an emission bandwidth of about 100 nm.

FIG. 7B is a graph illustrating spectral transmittances of filter regions 351, 352, 353, and 354. The spectral transmittances of filter regions 351 to 354 are indicated by solid line E21, dashed line E22, broken line E23, and dotted line E24, respectively. Here, the vertical axis of the graph is normalized by the maximum transmittance of filter region 351.

The transmittance of filter region 351 increases as the wavelength increases from about 570 nm, and maintains the maximum transmittance at about 650 nm or more. Filter region 351 mainly transmits light from light source 31 and forms a light region (dot light) having the hue “red”. Filter region 352 has spectral characteristics with a maximum transmittance of about 560 nm and a transmission wavelength width of about 160 nm, and mainly transmits light from light source 31 and light from light source 32 to form a light region (dot light) having the hue “orange”. Filter region 353 has spectral characteristics with a maximum transmittance of about 520 nm and a transmission bandwidth of about 150 nm, and mainly transmits light from light source 32 to form a light region (dot light) having the hue “green”. Filter region 354 has spectral characteristics with a maximum transmittance of about 460 nm and a transmission bandwidth of about 150 nm, and mainly transmits light from light source 33 to form a light region (dot light) having the hue “blue”.

Here, the filter having the four types of spectral transmittances has been described, but the present disclosure is not limited thereto, and for example, it is also possible to form more light regions (dot light) having different hues by adding a filter having a spectral transmittance that allows transmission of multiple wavelength ranges among the wavelength ranges of light source 31 to light source 33.

Next, a method in which measurement part 45 calculates a distance index value on the basis of the first image and the second image will be described.

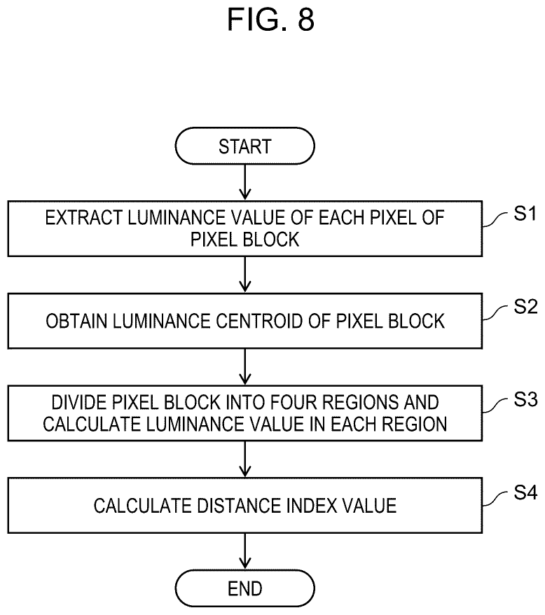

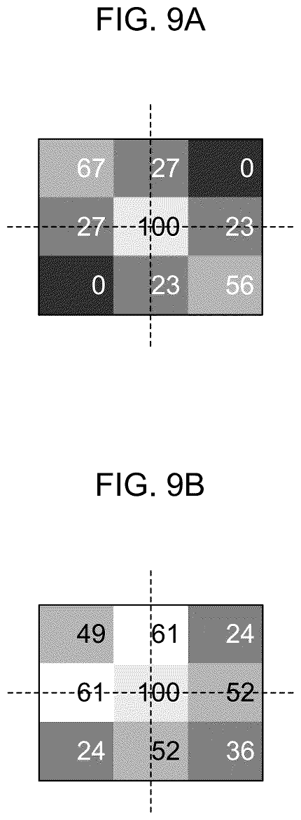

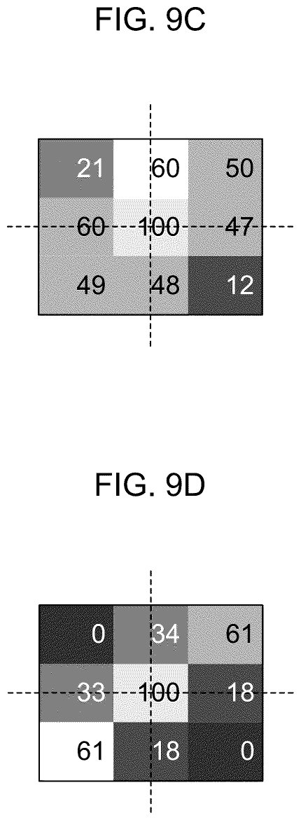

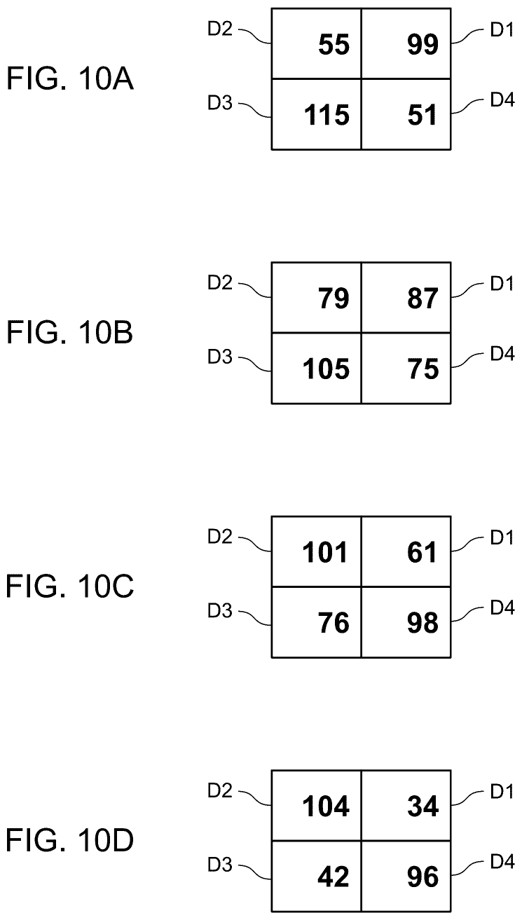

FIG. 8 is a flowchart for describing a method of calculating the distance index value of measurement part 45 according to the exemplary embodiment. FIGS. 9A to 9D are schematic diagrams illustrating examples of luminance values in a pixel block. FIGS. 10A to 10D are schematic diagrams illustrating examples of luminance values when a pixel block is divided into four regions. Specifically, FIGS. 9A to 9D illustrate luminance values in a case where the height of object A1 is h1 to h4, respectively. Further, FIGS. 10A to 10D illustrate luminance values when the pixel block of FIGS. 9A to 9D is divided into four regions, respectively.

Measurement part 45 extracts a luminance value of each of pixels included in one pixel block (step S1). For example, in a case where a pixel block is constituted by nine pixel regions 101 arranged in three rows and three columns, luminance values of the pixels constituting the pixel block are extracted (see FIGS. 9A to 9D).

Next, measurement part 45 obtains the luminance centroid of the pixel block on the basis of the extraction result in step S1 (step S2). Measurement part 45 divides the pixel block into four regions around the luminance centroid of the pixel block, and calculates a luminance value in each region (step S3). For example, the pixel block is divided into four regions by a straight line extending in the X direction and a straight line extending in the Y direction around the luminance centroid. At this time, the luminance is distributed to each region of the pixels existing on the straight lines according to the areas separated by the straight lines. In this manner, the luminance value in each region is calculated (see FIGS. 10A to 10D).

Then, measurement part 45 calculates the distance index value (step S4). Specifically, assuming that the luminance values of the upper right region, the upper left region, the lower left region, and the lower right region in one pixel block are D1 to D4, respectively (specifically, refer to FIG. 10A), the distance index value is expressed by the following formula (1).

$$\begin{matrix}[ Mathematical Formula 1 ] & \\ \frac{( D 1 + D 3 ) - ( D 2 + D 4 )}{( D 1 + D 2 + D 3 + D 4 )} & Formula ( 1 )\end{matrix}$$

FIGS. 11A and 11B are diagrams for describing a method of searching for a target pixel block according to the exemplary embodiment. Specifically, FIG. 11A is a diagram schematically illustrating a state in which target pixel block TB1 is set on first image 100, and FIG. 11B is a diagram schematically illustrating search range R0 set on second image 200 to search for target pixel block in FIG. 11A.

In FIG. 11B, for convenience, second image 200 acquired from second imaging part 20 is divided into multiple pixel blocks 202 similarly to first image 100. Pixel block 202 includes the same number of pixel regions as pixel block 102 described above.

In FIG. 11A, target pixel block TB1 is processing target pixel block 102 among pixel blocks 102 on first image 100. In addition, in FIG. 11B, standard pixel block TB2 is pixel block 202 on second image 200 corresponding to target pixel block TB1.

Measurement part 45 identifies standard pixel block TB2 corresponding to target pixel block TB1 on second image 200. Then, measurement part 45 sets the position of identified standard pixel block TB2 as standard position P0 of search range R0, and sets, as search range R0, a range extending in a direction in which first imaging part 10 and second imaging part 20 are separated from standard position P0.

Here, measurement part 45 identifies standard pixel block TB2 corresponding to target pixel block TB1 in the first image on the basis of the distance index value calculated in step S4 in FIG. 8. For example, measurement part 45 sets, as standard pixel block TB2, a pixel block corresponding to the calculated distance index value among the pixel blocks in the second image. More specifically, the amount of parallax with respect to the distance index value is calculated from the focal distance of imaging lens 11, 21, the distance (base-line length) between first imaging part 10 and second imaging part 20, and the pixel size of the imaging element, using a distance value corresponding to the distance index value measured and set in a table in advance. As a result, standard position P0 of search range R0 can be set to be close to the pixel block (fitted pixel block MB2) corresponding to target pixel block TB1, so that the processing load can be reduced.

A direction in which search range R0 extends is set to a direction in which the pixel block (fitted pixel block MB2) corresponding to target pixel block TB1 is shifted from standard position P0 on second image 200 due to parallax. Here, search range R0 is set in a range of 11 pixel blocks 202 arranged in the right direction from standard position P0 (direction corresponding to X-axis direction in FIG. 1). However, the number of pixel blocks 202 included in search range R0 is not limited thereto.

Measurement part 45 searches for a pixel block (fitted pixel block MB2) corresponding to target pixel block TB1 in set search range R0. Specifically, measurement part 45 calculates a correlation value between target pixel block TB1 and each search position while shifting the search position rightward by one pixel from standard pixel block TB2. As the correlation value, for example, a sum of squared difference (SSD) or a sum of absolute difference (SAD) is used. Then, measurement part 45 identifies, as fitted pixel block MB2, a pixel block at the search position having the highest correlation in search range R0.

Measurement part 45 further acquires the amount of pixel shift of fitted pixel block MB2 with respect to standard pixel block TB2. Then, measurement part 45 calculates the distance to the surface of object A1 by a triangulation method from the acquired amount of pixel shift and the separation distance between first imaging part 10 and second imaging part 20. Measurement part 45 executes similar processing for all pixel blocks 102 (target pixel block TB1) on first image 100. Upon acquisition of the distances for all pixel blocks 102 in this manner, measurement part 45 transmits information on these distances to an external device via communication interface 47.

For example, distance measurement device 1 is fixed to a conveyance device such as a belt conveyor, and is installed on an end-effector (such as gripper) of a robot arm that works and operates in a factory. In a case where the distance measurement device is installed on an end-effector of a robot arm, controller 46 of distance measurement device 1 receives an instruction to acquire distance from a robot controller via communication interface 47 in a work process of the robot arm. In response to this instruction, controller 46 causes measurement part 45 to measure the distance between the position of the end-effector and the surface of object A1 to be worked, and transmits the measurement result to the robot controller via communication interface 47. The robot controller feedback-controls the operation of the end-effector on the basis of the received distance information. As described above, in a case where distance measurement device 1 is installed on an end-effector, distance measurement device 1 is preferably small and lightweight.

### Modification

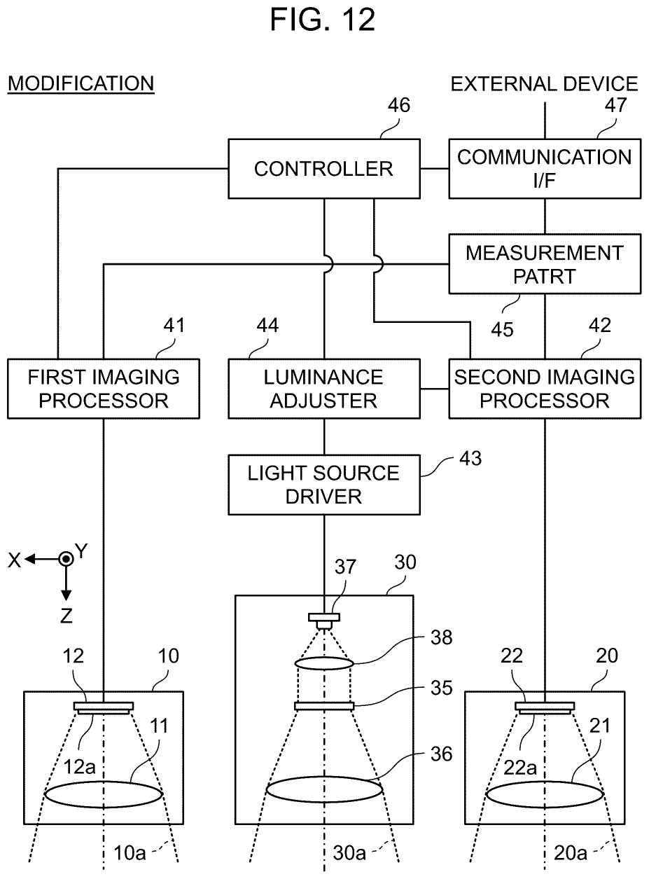

FIG. 12 is a diagram illustrating a configuration of a distance measurement device according to a modification. In the above exemplary embodiment, three light sources 31 to 33 are disposed in light projector 30, but in the present modification, only one light source is disposed in light projector 30.

Light projector 30 includes light source 37, collimator lens 38, filter 35, and projection lens 36. Light source 37 emits light of a wavelength band including selected wavelength bands of multiple types of filter regions 351 to 354. Light source 37 is, for example, a white laser diode. Collimator lens 38 collimates light emitted from light source 37. Collimator lens 38 constitutes an optical system that guides light from light source 37 to filter 35. Configurations of filter 35 and projection lens 36 are similar to those of the above exemplary embodiment. In addition, configurations other than light projector 30 are similar to the configurations in FIG. 2.

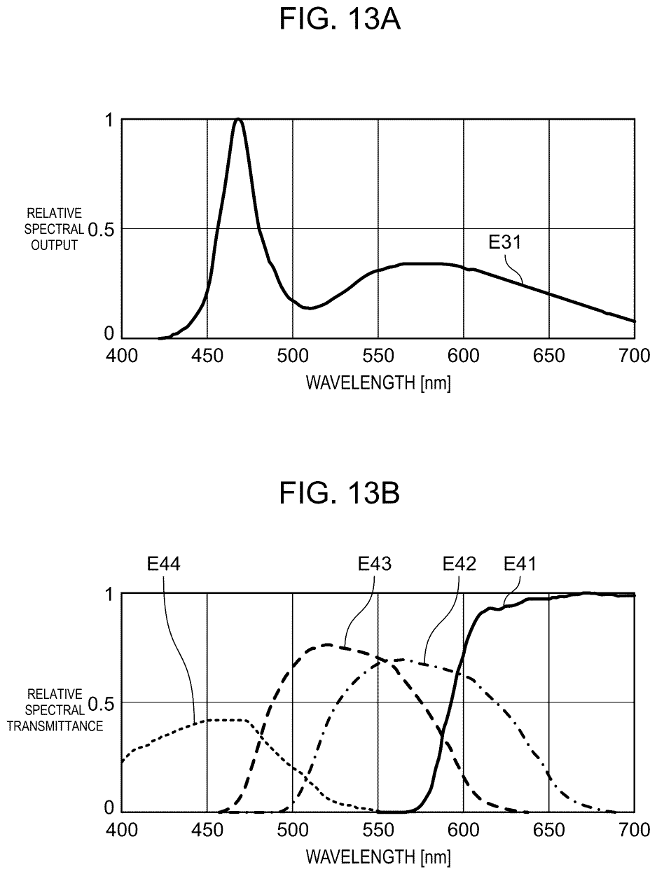

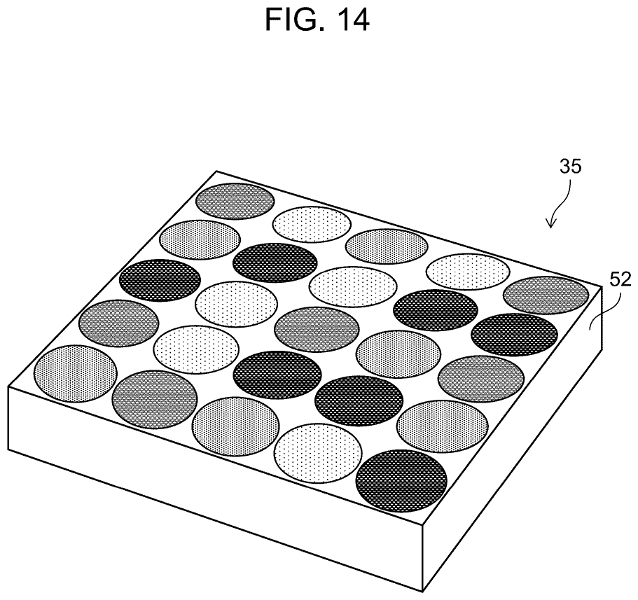

FIG. 13A is a graph illustrating a spectral output of light source 37. In FIG. 13A, the spectral output of light source 37 is indicated by solid line E31. FIG. 13B is a graph illustrating spectral transmittances of filter regions 351 to 354. In FIG. 13B, the spectral transmittances of filter regions 351, 352, 353, and 354 are indicated by solid line E41, dashed line E42, broken line E43, and dotted line E44, respectively.

As long as light source 37 has the spectral output of FIG. 13A and filter regions 351 to 354 have the spectral transmittances of FIG. 13B, the same effect as that of the above exemplary embodiment can be obtained in the present modification.

In the above exemplary embodiment, the shape of each filter region formed in filter 35 (filter layer 52) is rectangular in plan view (see FIG. 5B), but the present invention is not limited thereto. For example, as illustrated in FIG. 14, the shape of each filter region formed in filter 35 (filter layer 52) may be circular or any shape in plan view.

Furthermore, distance measurement device 1 may be provided with a light projection controller that adjusts the luminance of light emitted from the light source included in light projector 30. For example, a light projection controller may be provided as a part of controller 46 in FIG. 2 and FIG. 12.

### INDUSTRIAL APPLICABILITY

The distance measurement device of the present disclosure can reduce time required for distance measurement while increasing resolution. Thus, the distance measurement device of the present disclosure enables measurement with higher accuracy and higher efficiency in three-dimensional measurement, and is industrially useful.

### REFERENCE MARKS IN THE DRAWINGS

1 distance measurement device
10 first imaging part
20 second imaging part
30 light projector
30a pattern light
31 to 33, 37 light source
35 filter
45 measurement part
53 microlens (optical element)

1. A distance measurement device comprising:
a first imaging part and a second imaging part that are disposed side by side, visual fields of the first imaging part and the second imaging part having a range overlapping with each other;
a light projector that projects pattern light in the range in which the visual fields overlap with each other, the pattern light having a plurality of light regions of different wavelength bands, the plurality of light regions being distributed in a predetermined pattern; and
a measurement part that measures a distance to a surface of an object, on which the predetermined pattern light is projected, based on images captured by the first imaging part and the second imaging part,
wherein
the light projector includes:
a light source including the wavelength bands,
a filter including a plurality of filter regions for respectively forming the plurality of light regions, the plurality of filter regions being distributed in a pattern similar to the predetermined pattern of the light regions, and
a plurality of optical elements that are arranged on at least one of an incident surface side and an emission surface side of the filter, the plurality of optical elements corresponding to the plurality of filter regions, and
each of the plurality of optical elements has two different focal points and forms a corresponding one of the plurality of light regions.

2. The distance measurement device according to claim 1, wherein the optical element includes a first focal point and a second focal point having a focal length longer than a focal length of the first focal point, and is a lens having a first curvature radius and a second curvature radius different from the first curvature radius, the first curvature radius being a curvature radius in a first direction and a second curvature radius being a curvature radius in a second direction intersecting the first direction.

3. The distance measurement device according to claim 2, wherein the first direction is substantially orthogonal to the second direction.

4. The distance measurement device according to claim 2, wherein
the first focal point is set on a side closer to the distance measurement device than a measurement range of the distance measurement device, and
the second focal point is set on a side farther from the distance measurement device than the measurement range.

5. The distance measurement device according to claim 1, wherein
the light source includes a plurality of light sources that emit light beams having different wavelength bands, and
the light projector further includes an optical system that guides the light beams, emitted from the plurality of light sources, to the filter.

6. The distance measurement device according to claim 1, wherein the plurality of filter regions each extract light of a wavelength band corresponding to a hue of a corresponding one of the light regions among light emitted from the light source.

7. The distance measurement device according to claim 1, further comprising a light projection controller that adjusts luminance of light emitted from the light source.

8. The distance measurement device according to claim 1, wherein the measurement part performs stereo corresponding point search processing on a first image captured by the first imaging part and a second image captured by the second imaging part.

9. The distance measurement device according to claim 8, wherein, in the stereo correspondence point search processing, the measurement part selects a standard block from the first image, extracts a light region pixel block including a corresponding one of the light regions in the selected standard block, calculates a distance index value to a surface, on which the corresponding one of the light regions is projected, based on a pixel value of the light region pixel block, and determines a search start position of a reference pixel block in the second image based on the distance index value.
